(19) United States
(12) Patent Application Publication
(10) Pub. No.: US 2015/0186819 A1
(43) Pub. Date: Jul. 2, 2015

(54) ORGANIZATIONAL INSIGHTS AND MANAGEMENT OF SAME

(71) Applicant: Cox Communications, Inc., Atlanta, GA (US)

(72) Inventors: Dipan Patel, Atlanta, GA (US); Lisa Maree Woods, Atlanta, GA (US); Brent Joseph Comstock, Atlanta, GA (US); Haynes Taylor, Atlanta, GA (US)

(73) Assignee: COX COMMUNICATIONS, INC., Atlanta, GA (US)

(21) Appl. No.: 14/145,732

(22) Filed: Dec. 31, 2013

(51) Int. Cl. G06Q 10/06

(52) U.S. Cl. CPC G06Q 10/0637; G06Q 10/06375

(57) ABSTRACT

Aspects of the disclosure include generation of organizational intelligence, such as organizational features, associated with an organization. In one aspect, an organizational feature can be based at least on organizational and non-organizational information. In another aspect, certain organizational features can be obtained, for example, from correlations present in the organizational and/or non-organizational information. At least one of such features can may be referred to as organizational insight, and can be represented with a function and/or a group of concepts drawn from the information relied on or otherwise leveraged for determination of the insight. Regardless of complexity, in yet another aspect, certain features of the disclosure can be analyzed, modeled, and/or simulated. In addition or in the alternative, in at least certain aspects, operational recommendations for the organization can be generated. In other aspects, the organization can be emulated based at least on organizational features obtained from actual and/or artificial information.

### BACKGROUND

Conventional approaches for analysis of performance of an organization typically focus on data available within an industry vertical associated with the organization. Such approaches also tend to dismiss non-organizational information. As greater sources of information become available to an organization, and greater activities (e.g., offline and online activity) may affect organizational performance, the analysis of the performance based on conventional approaches tends to become near-sighted and inadequate.

### BRIEF DESCRIPTION OF THE DRAWINGS

The accompanying drawings are an integral part of the disclosure and are incorporated into the present specification. The drawings illustrate examples of embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as being limited to the implementations set forth herein. Like numbers refer to like elements throughout.

FIG. 1 presents an example of an operational environment in accordance with one or more aspects of the disclosure.

FIG. 2 presents an example of an interface in accordance with at least certain aspects of the disclosure.

FIG. 3 presents an example embodiment of an operational environment in accordance with at least certain aspects of the disclosure.

FIG. 4 presents an example of a operational environment in which at least certain functionality may be implemented in accordance with at least certain aspects of the disclosure.

FIGS. 5-6 present examples of techniques in accordance with at least certain aspects of the disclosure.

### DETAILED DESCRIPTION

The disclosure recognizes and addresses, in one aspect, the issue of determination and management of actionable information associated with organizations. The disclosure provides devices, systems, techniques, and/or computer program products for generation of organizational intelligence (which also may be referred to as institutional intelligence) and management thereof—e.g., acquisition and/or management of organizational features associated with an organization. As described in greater detail below, in one aspect, the disclosure permit extraction of features that may present in organizational information and/or non-organizational information associated with an organization. Organizational information can include information indicative of transactions conducted at the organization, such as till receipts; information indicative of contemporaneous or historical revenue; information indicative of personnel payroll; operational costs; and the like. Non-organizational information can include information that can be pertinent to the organization even though it may be obtained or generated outside the organization. As an illustration, non-organizational information can include service provider information (e.g., trends in customer web-search queries, web-page view statistics, or the like); external information (e.g., information indicative of weather conditions, traffic conditions, market conditions, local public events, national holidays, and the like); competitive information, such as information available from competitors with the organization; social media information; and the like. Based on such information, the disclosure permit generation and/or determination of increasingly complex features based at least on such information. Features having high complexity can be referred to as knowledge or insight and can be obtained, for example, from correlations present in the organizational and/or non-organizational information. Such insight may be referred to as organizational insight, and can be represented with a function and/or a set of one or more concepts drawn from the information relied on or otherwise leveraged for determination of the insight. Regardless of complexity, in another aspect, certain features of the disclosure can be analyzed, modeled, and/or simulated. In addition or in the alternative, in at least certain aspects, the disclosure can permit emulation of an organization.

While various aspects of the disclosure are illustrated in connection with small business entities, it should be appreciated that the disclosure is not so restricted and such aspects can be applied to most any organization having a workforce (e.g., business management and employees) and that provides a service and/or a product. In addition, in the disclosure, an organization can pertain to an industry vertical that can be embodied in or can comprise (i) agriculture; (ii) education and childcare; (iii) insurance services; (iv) Internet and online market; (v) not-for-profit; (vi) retail and consumer services; (vii) utilities; (viii) banking and financial services; (ix) hospitality and travel services; (x) legal services; (xi) law enforcement; (xii) media and entertainment; (xiii) real estate and property; (xiv) transportation and logistics; (xv) construction; (xvi) energy and environment; (xvii) healthcare and pharmaceuticals; (xviii) manufacturing and engineering; (xix) public sector; (xx) gastronomy services; (xxi) small businesses; or the like. In addition, small businesses or medium businesses also can be organized in business verticals or segments, such as auto dealer; auto repair or workshop; general contractor; landscaping and land management; customer loyalty; consumer goods distribution; good distribution; franchise management; funeral industry; jewelry store management; pharmacy; photographic studios; salons; service dispatch; restaurants; personal services; office services; small office; home office; and the like.

Embodiments of the disclosure can provide various advantages over conventional technologies for identification of organizational features associated with an organization. One example advantage may include availability of rich information originated in a variety of disparate source platforms that can be mined automatically in time scales having various resolution, including in realtime or nearly in realtime. As the information that can be relied upon for the determination and/or management of organizational insights is not collected automatically as opposed to manually, the information streams available for such determination and/or management can be mined nearly continuously in certain embodiments, with the ensuing availability of nearly realtime assessment (e.g., correlation generation and/or identification of trends) and/or planning of the operation of an organization. Another example advantage may include dynamic generation and/or revision of available organizational knowledge, which can include a collection of organizational insights. Yet another advantage may include the specificity of the organization knowledge that is provided in accordance with aspects of the disclosure. The organizational insights are specific to an organization and its environment, rather than generic to certain segment or industry vertical of the organization. The specificity of the organizational insights includes specificity in time-domain (e.g., an insight applicable or otherwise pertinent to certain day of the week, such effect of gas prices on customer traffic on a Friday) and/or space-domain.

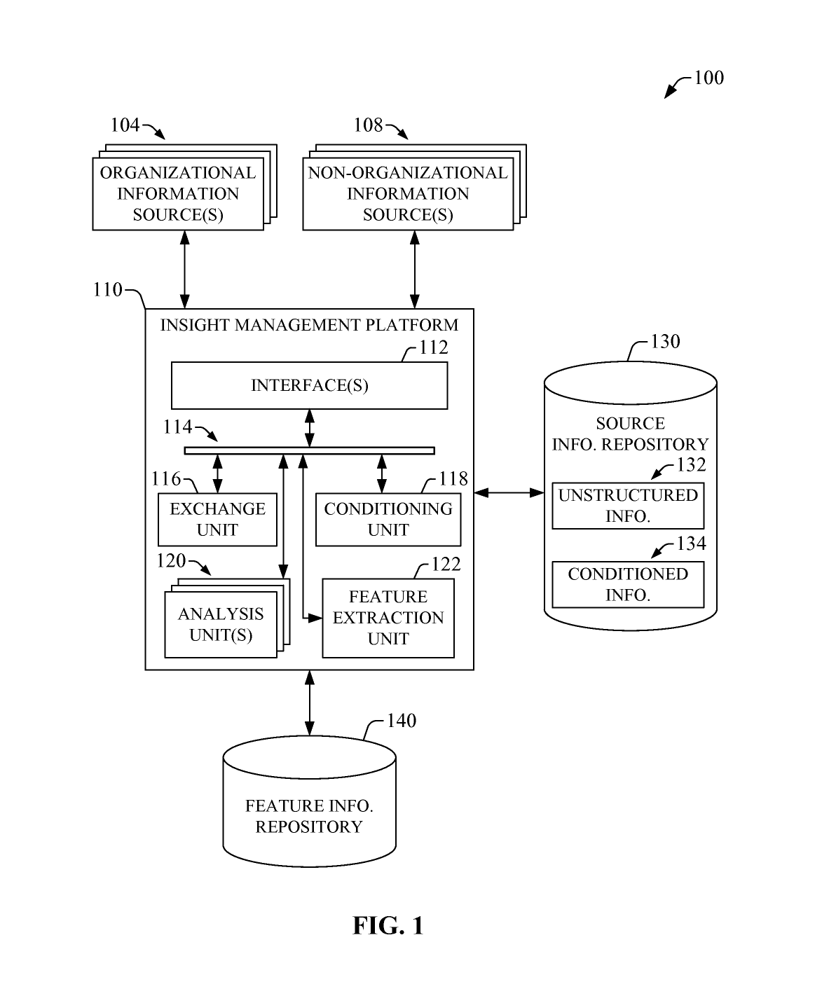

With reference to the drawings, FIG. 1 presents an example of an operational environment 100 in accordance with at least certain aspects of the disclosure. As illustrated, the operational environment 100 can include a group of sources of information (e.g., data, metadata, and/or signaling) associated with an organization, where the group can include one or more organizational information sources 104 and/or one or more non-organizational information sources 108. At least one (e.g., one, two, more than two, each) of such information sources can embody or can be contained within a platform, which may be referred to as source platform. The organizational information source(s) 104 can include organizational information structures (e.g., datasets) including till receipts, product inventory, product prices, staffing levels, combinations thereof, and the like). The information structures can include information that is time-dependent, such as an information stream including records at various instants (e.g., a data, a time of day, a time of week, a time of month, or the like), which can be historical instants or forecasted instant. In addition, the non-organizational information source(s) 108 can include one or more categories of information, such as service provider information, external information, competitive information, social media information, combinations thereof, or the like. For instance, service provider information can include trends in consumer web-based searches, web-page view statistics, television viewing (including programs and advertisement), pay-per-view asset consumption, and so forth. Certain service provider information can be arranged or otherwise ranked by viewership popularity. External information can include environmental information (e.g., temperature or other weather conditions, smog levels, pollen counts, humidity, or the like); econometric (e.g., local economy indicators, such as employment metrics); and/or local information (e.g., traffic levels, gasoline prices, airport delays, local events (shows, football games, . . . ), local and national holidays, and so forth). Competitive information can include publically available information associated with an organization (e.g., a hotel), such as hotel room pricing, product pricing, trending product sales, sales and promotional campaign (e.g., loyalty programs, credit cards, . . . ), and so forth. Social media information can include information identifying customers and/or end-user posts that reference an organization. In certain embodiments, non-organizational information structures can include information that is time-dependent, such as an information stream including records at various instants (e.g., a data, a time of day, a time of week, a time of month, or the like), which can be historical instants or forecasted instant.

Each of the organizational information source(s) 104 and/or the non-organizational information source(s) 108 can supply data, metadata, and/or signaling to an insight management platform 110. To at least such an end, in one aspect, a source of such information source(s) can expose and/or communicate data, metadata, and/or signaling via an interface in response to a query (e.g., a request for data, a search query) or an event (e.g., a data fulfillment protocol).

In addition, in certain embodiments, each the organizational information source(s) 104 and the non-organizational information source(s) 108 can be coupled (e.g., communicatively coupled or otherwise functionally coupled) to an insight management platform 110 that can generate an organization insight based at least on information acquired or otherwise received from at least one of such source(s). To at least such an end, in one aspect, the insight management platform 110 can receive a group of information streams via at least one interface of one or more interfaces 112 (also referred to as interface(s) 112). The group of information streams can be received from a group of source platforms during a predetermined period, where the group of source platforms can include at least one of the organizational information source(s) 104 and/or at least one of the non-organizational source(s) 108. In one implementation, an exchange unit 116 can configure or otherwise determine at least a portion of the group of source platforms, and can acquire an information stream via the at least one interface. To at least such an end, the exchange unit 116 can perform a procedure for acquisition of the information stream in accordance with an acquisition criterion.

Information streams that can be received at the insight management platform 110 can include unstructured data and/or metadata. The insight management platform 110 can retain at least a portion of such information within one or more memory elements 132 (referred to as unstructured info. 132) contained in a source information (info.) repository 130. In one implementation, the exchange unit 116 can utilize or otherwise leverage an interface of the interface(s) 112 to communicate information include in the information streams to the organizational information repository 130.

The insight management platform 110, via a conditioning unit 118, for example, can condition or otherwise organize at least a portion of a group of information streams in order to extract a feature from the information conveyed in such a group. A feature can include a pattern, a classification, a value of a function (multivariate or otherwise), an inference, a combination thereof, or the like. At least the portion of the plurality of information streams can include at least two information streams, which can permit or otherwise facilitate extraction of rich features via identification of correlations between such streams. Information that is conditioned as described herein can be retained within one or more memory elements 134 (referred to as conditioned info. 134) contained in the source info. repository 130. In certain implementations of information conditioning, the conditioning unit 118 can parse information included in at least the portion of the group of information streams, and can configure the information for feature extraction. In one aspect of information configuration, the conditioning unit 118 can format the information accordance with a format suitable to implement a map-reduce scheme. In an additional or alternative aspect of information conditioning, the conditioning unit 118 can normalize at least a portion of the information included in each stream of at least the portion of the group of information streams.

Normalization of information streams can permit comparing data and/or metadata associated with information included in information streams from different source platforms and/or information that pertains to different categories or information types within a single information stream. In one aspect, an indexing rule can be determined (e.g., identified or defined) to establish a specific normalization of information acquired or otherwise accessed from a source platform. The indexing rule can be specific the information and/or the source platform, and can be represented, for example, as metadata associated with the information. In an implementation of normalization, the conditioning unit 118 can index information according to the indexing rule. Indexing rules can be determined or defined in time domain, frequency domain, space domain, category domain, or the like. Indexing rules can be dynamically updated by a learning engine (or learning unit) and by analysis of the data sets being stored by the system. The analysis unit(s) 120 can include the learning engine that can generate information and/or knowledge according to various machine-learning techniques (e.g., classification, regression, clustering, ensemble learning, Bayesian inferences, combinations thereof, and so forth). Time-domain rules.—The indexing process can determine if the information is regular or otherwise distributed homogeneously, and if so what the frequency of an information structure (e.g., a datum) is. In a simple dataset (e.g., a dataset having one record or datum per day), the dataset can be indexed as daily. If datasets include records or other information structures that are non-homogeneous, or irregularly distributed in time-domain, the learning engine can identify or otherwise determine an index that conveys where to identify an actual date stamp for a record or information structure, and how to interpret frequency components of the information structures in a dataset for downstream systems. Indexing under time-domain rules also can determine how a downstream system or unit (e.g., an analysis unit) can interpolate the value of an information structure (e.g., a datum, a list of data, or the like) when, for example, a value for an information structure does not occur for a certain date under analysis. More specifically, yet not exclusively, if a downstream system or unit (e.g., the feature extraction unit 122) relies on a value from a dataset having non-homogeneously distributed information structures, and one does not exist for the time period under consideration, then the index created during the normalization process can indicate how to estimate or otherwise generate the data that may me necessary from other values in the data set. As an illustration, if a value for an organization metric (e.g., manufactured bolts) for 12:05 pm is needed from a dataset having data that is generated by a source platform once every hour, the index created during normalization may explain that the data value to be used should be the weighted average of the adjacent values of the organization metric from 12:05 pm, e.g., 12:00 pm and 1:00 pm. Space-domain rules.—Similar to normalization in time-domain, indexing according to aspects of the disclosure can determine how granular the data is (or otherwise how that data is distributed) with respect to geographic location—e.g., geographical information system (GIS) location, ZIP code, regional, county, state, and the like. The indexing can determine how to understand a data element and its relationship to the most granular measurement or any measurement with higher granularity. Category-domain rules.—Normalization also can be implemented according to a category dimension representative or indicative of applicability to a certain category of business or organization. For example, indexing based on a category can be implemented by determining applicability of a dataset or information object to North American Industry Classification System (NAICS) codes and by size of business. In one aspect, the indexing or the learning engine that implements the indexing can assign a code that can be used by downstream systems or units to determine applicability to an organization, and how to normalize (e.g., pad or complete) an information object (e.g., a list of data) in a scenario in which category information (e.g., data and/or metadata) is unavailable. In addition or an alternative to normalization based on NAICS codes, organizational information available from a source platform can be normalized based at least on proprietary information that is indicative or that otherwise characterizes an organization associated with the organizational information. The proprietary information can be associated with a service provide that administers the insight management platform 110, for example.

A feature extraction unit 122 in the insight management platform 110 can extract a feature associated with a business organization from information that has been conditioned as described herein. Extraction of such a feature can include determination or otherwise identification of correlations between at least two information streams contained in a group of information streams that are received and conditioned at the insight management platform 110. In certain implementations, correlations can be multivariate correlations between information sets determined by respective functions of N variables (e.g., real or complex), with N a natural number greater than unity. For example, correlations between data sets dependent on four variables can be performed. In one aspect of correlation implementation, the feature extraction unit 122 can identify a first and second information streams, and can access (e.g., collect or receive) respective normalized information (e.g., data and/or metadata) for such streams for a specific time interval. In addition, the feature extraction unit 122 can analyze each of the first and second information streams and can ascertain whether a pattern or trend is present in the normalized information respectively associated with such information streams. For instance, if the time interval spans several months, the feature extraction unit 122 can determine if a trend is present by season and/or month. In addition, the feature extraction unit 122 can analyze the first and second information streams jointly in order to determine a correlation—e.g., the feature extraction unit 122 can analyze if values in one having any correlation in the other (statistically speaking) It should be appreciated that values also can be trends within data (e.g., when determined that in the period under question the weather is progressively warmer by day of week, or if register sales are typically decreasing during first week in November). The feature extraction unit 122 can implement one or more pattern recognition techniques in order to ascertain or otherwise identify a pattern or trend.

In addition to determination of correlation metrics (in time domain, space-domain, and/or category-domain), the feature extraction unit 122 can implement (e.g., apply) various models representative of correlation between two or more information streams in order to determine statistical significance of an evaluated correlation. More specifically, yet not exclusively, the feature extraction unit 122 can apply different correlation premises to a plurality of information streams, where two or more information streams are selected according to a correlation premise and a correlation metric is determined for the two or more information streams. For instance, for a group of seven information streams, a correlation premise can convey that certain two information streams (e.g., one organizational information stream and one non-organizational information stream) are correlated, and correlation metric(s) for the two or more information streams can be determined by the feature extraction unit 122. The higher the statistical significance of a correlation metric for a specific correlation premise, the higher the relevancy of such a premise.

The insight management platform 110 can retain extracted features in a feature information repository 140. The extracted features that are retained can be structured or otherwise organized based on various factors, such as source platform that originated at least certain information stream relied upon for extraction of the feature, a category representative of feature domain, a business metric (e.g., a key performance indicator (KPI)) or other industry relevancy metric; a time span, or the like. In addition or in the alternative, the extracted features can be retained in a collection of historical features, which can permit or otherwise facilitate time-resolved analysis of such features.

It can be appreciated that, in one aspect, an organizational feature described herein can represent knowledge related to operation of an organization. The organization feature can be represented or otherwise characterized by (i) a function of one or more variables, and/or (ii) at least one conclusion or concept derived from the feature extraction analysis described herein. For example, a concept can be inferred from organizational and/or non-organizational information via machine-learning techniques for generating inferences based on statistical models. Accordingly, determination of organizational features can permit analysis of an organization based at least on organizational factors and/or non-organizational factors, where such factor(s) can establish a specific environment of the organization. The analysis can include root-cause analysis, modeling, simulation, emulation, combinations thereof, and the like. Further, an organization feature can permit or otherwise facilitate organizational action, such configuration of automated events and/or actions (e.g., initiate an email marketing campaign). In certain embodiments, the insight management platform 110 can include one or more analysis units 120 (referred to as analysis unit(s) 120) that can perform the described analysis individually and/or collectively. In one embodiment, at least one of the analysis unit(s) 120 can determine or otherwise identify a pattern within historical features. It should be appreciated that a pattern of features is a feature. A pattern of features can be represented with a function and/or a group of concepts, where the function and/or at least one concept can be utilized or otherwise leveraged to predict a condition of an organization associated with such a pattern based at least on a set of one or more variables and/or other input structure(s). The at least one of the analysis unit(s) 120 can determine a confidence metric related to the confidence of a statistical model that can yield the pattern of features and the amount of information (e.g., data sampling) utilized for pattern extraction and/or evaluation of the function representative or otherwise indicative of the pattern of features. For instance, in a scenario in which a prediction comprises significant extrapolation of data elements, the confidence metric of the prediction can be low. In addition or in the alternative, the confidence metric also can be low in a scenario in which a regression metric (such as an R² value) for the statistical correlation related to the statistical model is low. It should be appreciated that, in one aspect, fidelity of a prediction can be increased based on historical values of an organizational feature, and/or actual operational information collected after a prediction.

In certain embodiments, simulation of organizational insights can be implemented. In such embodiments, the insight management platform 110 can receive artificial information streams (organizational streams and/or non-organizational streams) that can be utilized or otherwise leveraged to extract organizational features in accordance with aspects described herein. The artificial information streams (which also may be referred to as “synthetic information streams”) can include operator-driven information, such as a specific time interval; specific values of external or competitive information (e.g., data and/or metadata); combinations thereof; or the like. At least a portion of the artificial information can be utilized or otherwise leveraged to extract a feature in accordance with aspects described herein. In addition, at least one of the analysis unit(s) 120 can generate a prediction based at least on such a feature. The prediction can represent a simulation of organizational insights. For example, the simulation can provide the time dependence of a business metric over an operator-specific period.

In certain scenarios, the conditioning unit 118 can generate artificial information streams for a simulation. For instance, an operator (e.g., an officer of an organization) may provide a request to simulate what sales were if “summer was hotter than normal.” In such scenario, the conditioning unit 118 can develop information streams indicative or representative of a hotter summers based on a specific bias provided by the operator (e.g. “hotter” can be a scale from 1-5 times greater from predicted value), and at least one of the analysis unit(s) 120 can extract organizational features based at least on higher summer temperatures. To at least such an end, in one aspect, the at least one of the analysis unit(s) 120 can receive or otherwise access (e.g., retrieve) at least a portion of the artificial information, and based on at least a portion of the information that is accessed, the at least one of the analysis unit(s) 120 can generate information indicative or otherwise representative of organizational features based at least on higher summer temperatures. It should be appreciated that, in at least certain aspects, the conditioning unit 118 can generate artificial information indicative of other environments of an organization (e.g., a period of high prices of gasoline, state of local economy, or the like), and one or more of the analysis unit(s) 120 can access such information and can generate information indicative or otherwise representative of organizational features for one or more of the environments that are contemplated via the artificial information. At least a portion of the information indicative or otherwise representative of organizational features can be supplied in order to identify a satisfactory operational path forward (e.g., reduction of workforce, replacement of vendor, etc.) for an organization associated with the organization features. A satisfactory path forward can include a best path forward, a second best path forward, and/or the like.

Prediction and/or simulation in accordance with aspects of the disclosure can be utilized or otherwise leveraged to determine or otherwise identify organizational metrics that satisfy an objective of an organization. An operator associated with the organization (e.g., a manager of the organization) can specify the objective. The organizational metrics can include, for example, inventory, staffing level, price elasticity, a combination thereof, or the like. In one aspect, such metrics can be determined or otherwise identified based at least on historical and/or predicted values of organizational information and/or non-organizational information. At least one of analysis unit(s) 120 can access the historical or predicted information, and can determine an organization metric that can satisfy the specific organizational need optimally or nearly optimally. The organizational metrics so determined can embody or can constitute a recommendation, and it should be appreciated that, in one aspect, operation of the organization according to such a recommendation can influence or otherwise shape at least the organizational information that is associated with the organization.

It should be appreciated that while the analysis unit(s) 120 and the feature extraction unit 122 are illustrated as separate functional elements, embodiments in which the feature extraction unit 122 is integrated into the analysis unit(s) 120 also are contemplated. In addition, it should be appreciated that two or more of the functional elements (e.g., units, interfaces, and the like) can exchange information via a communication platform 114 (e.g., wireless links, wireline links, reference links, middleware, bus architectures, combinations thereof, or the like). Similarly, a functional element of the insight management platform 110 can communicate information (e.g., transmit information, receive information, retrieve information, or the like) to and/or from at least one of the feature information repository 140 or the source information repository 130.

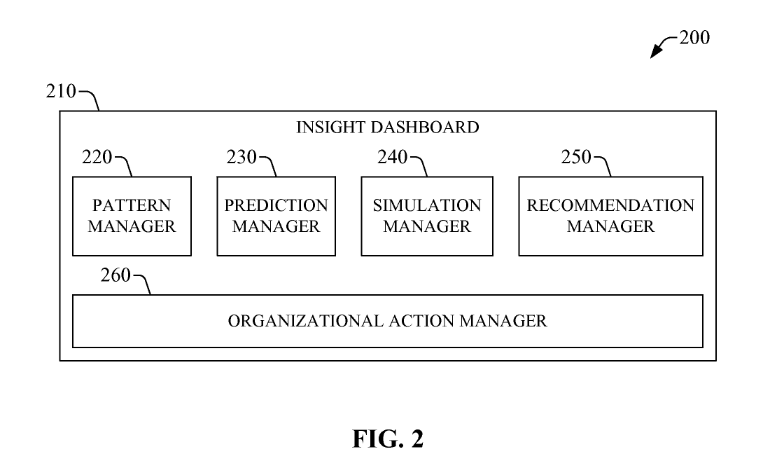

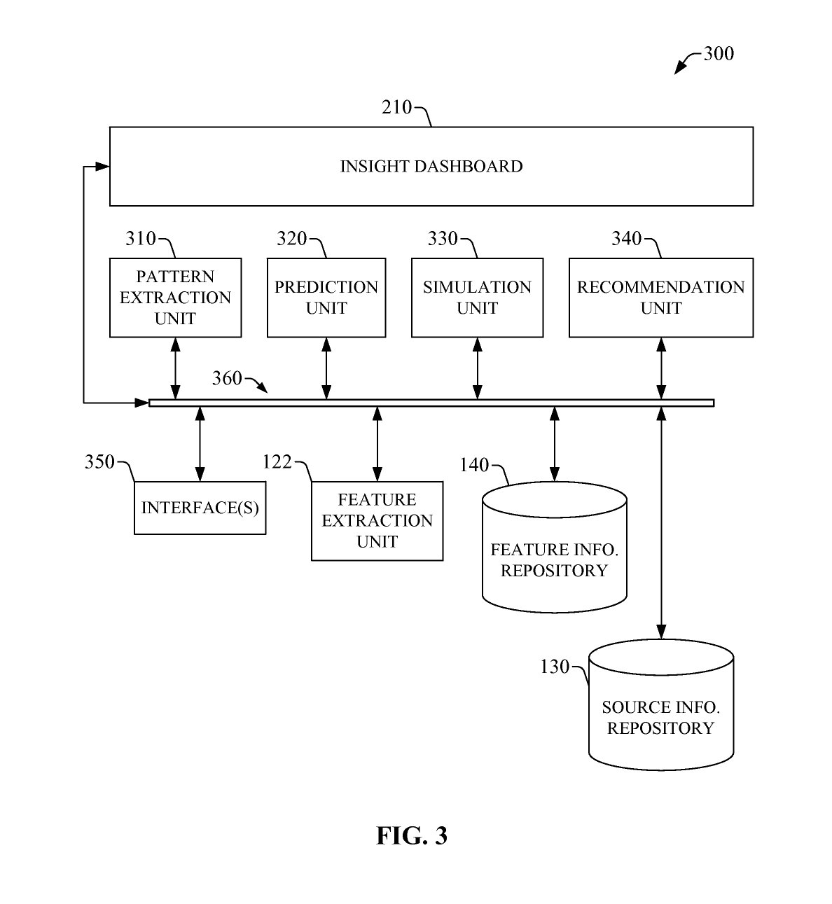

In certain embodiments, an interface of the interface(s) 112 can permit access to or implementation of various aspects of the analysis described herein. As illustrated in FIG. 2, such an interface can include an insight dashboard 210 that can provide access to various analyses of information (e.g., data, metadata, and/or signaling) retained in the source info. repository 130 and/or the feature information repository 140. The insight dashboard 210 can include groups of one or more indicia that can permit or otherwise facilitate consumption of information and/or utilization of at least one of the analysis unit(s) 120 via interaction with at least one indicia in one or more of such groups. Such an interaction can include gestures relative to the at least one indicia and/or actuation thereof. In addition, interaction with the at least one indicia can direct (e.g., communicate an instruction) an analysis unit of the analysis unit(s) 120 to perform certain analysis and/or to retrieve certain information structure (e.g., a datum, a time series, or the like) from at least one of the source information repository 130 or the repository 140. In certain embodiments, such as example embodiment 300 illustrated in FIG. 3, the analysis unit(s) 120 can include a pattern extraction unit 310, a prediction unit 320, a simulation unit 330, and a recommendation unit 340. Such units can implement at least some of the analyses described herein. In addition, two or more of such units can exchange information (e.g., data, metadata, and/or signaling) via one or more programming interfaces 350, which can include application programming interface(s) (API(s)) and a communication platform 360 (e.g., wireless links, wireline links, reference links, middleware, combinations thereof, or the like). The communication platform 360 can constitute the communication platform 114. At least one of the interface(s) 350 and/or the communication platform also can permit communication of information (e.g., signaling, such as instructions or directives) between the insight dashboard 210 and at least one of the pattern extraction unit 310, the prediction unit 320, the simulation unit 330, or the recommendation unit 340. Similarly, at least one of the interface(s) 350 and the communication platform 360 can permit at least one of the prediction unit 320, the simulation unit 330, or the recommendation unit 340 to access (e.g., retrieve or otherwise collect) information from and/or push (e.g., transmit) information to the feature information repository 140 and/or the source information repository 130.

As illustrated, the insight dashboard 210 can include a first group of one or more indicia (referred to as pattern manager 220) that can permit or otherwise facilitate consumption (e.g., rendering in a visual interface and/or aural interface) or interaction with a pattern across information source(s) of the organizational information source(s) 104 and/or non-organizational information source(s) 108. In addition or in the alternative, the pattern manager 220 can permit consumption or interaction with information elements (e.g., a view) of the source information repository 130 and/or the feature information repository 140. In order to permit at least some of such functionality, in embodiments such as example embodiment 300, for example, the pattern manager 220 can communicate an instruction to the pattern extraction unit 310 to identify a pattern in organization features (or insights) across organizational metrics. The pattern extraction unit 310 can receive the instruction and in response, can identify such a pattern (e.g., time-domain pattern in a time series of values for a business metric, such as revenue).

The insight dashboard 210 also can include a second group of one or more indicia (referred to as prediction manager 220) that can permit or otherwise facilitate consumption (e.g., rendering in a visual interface and/or aural interface) or interaction with predictions of organizational features and/or an information object associated the organizational information source(s) 104 and/or the non-organizational information source(s) 108. As an illustration, the information object can include a datum indicative of revenue for certain period, such as a day, a week, a month, a quarter, a year, or the like. In order to permit at least some of such functionality, in embodiments such as example embodiment 300, for example, the prediction manager 230 can communicate an instruction to the prediction unit 320 to calculate, for example, values of an organizational feature or an organizational information structure at a future time based at least on historical values of organizational features and/or impact of correlations of non-organizational information. The prediction unit 310 can receive the instruction and in response, can generate such values.

In addition, the insight dashboard 210 can include a third group of one or more indicia (referred to as simulation manager 240) that can permit or otherwise facilitate consumption (e.g., rendering in a visual interface and/or aural interface) or interaction with predicted organizational features based at least on operator-provided ranges or other inputs for organizational and/or non-organizational parameters. In order to permit at least some of such functionality, in embodiments such as example embodiment 300, for example, the simulation manager 240 can communicate an instruction to the simulation unit 330 to calculate values of an organizational feature over an operator-configured time frame. In addition or in the alternative, the simulation manager 240 can communicate another instruction to the simulation unit 330 to calculate values of an organizational feature based at least on operator-configured values of non-organizational information, such as external data and/or competitive data. The simulation unit 330 can receive such instructions and in response, can generate such values.

As illustrated, the insight dashboard 210 can further include a fourth group of one or more indicia (referred to as recommendation manager 250) that can permit or otherwise facilitate consumption (e.g., rendering in a visual interface and/or aural interface) or generation with recommendations for organizational information (e.g., data and/or metadata) based at least on prediction of information values at a future time. In order to permit at least some of such functionality, in embodiments such as example embodiment 300, for example, the recommendation manager 230 can communicate an instruction to the recommendation unit 320 to determine or otherwise identify organizational metrics based at least on historical and/or predicted values of organizational information and/or non-organizational information, where the organizational metrics satisfy a specific organizational need. The organizational metrics can include, for example, inventory, staffing level, price elasticity, a combination thereof, or the like. In addition, the organizational metrics can include metrics that can satisfy the specific organizational need optimally or nearly optimally. The recommendation unit 340 can receive the instruction and in response, can generate such organizational metrics.

Further, the insight dashboard 210 can include a fifth group of one or more indicia (referred to as organizational action manager 250) that can permit or otherwise facilitate organizational action, such as configuration of automated events and/or actions (e.g., initiate an email marketing campaign).

It should be appreciated that, in certain embodiments, any two or more of the groups of indicia described herein can be consolidated into a single group of indicia providing the composite functionality of the groups that are consolidated. For instance, the prediction manager 230 and the simulation manager 240 can be consolidated into a single group of indicia providing the prediction and simulation functionality described herein.

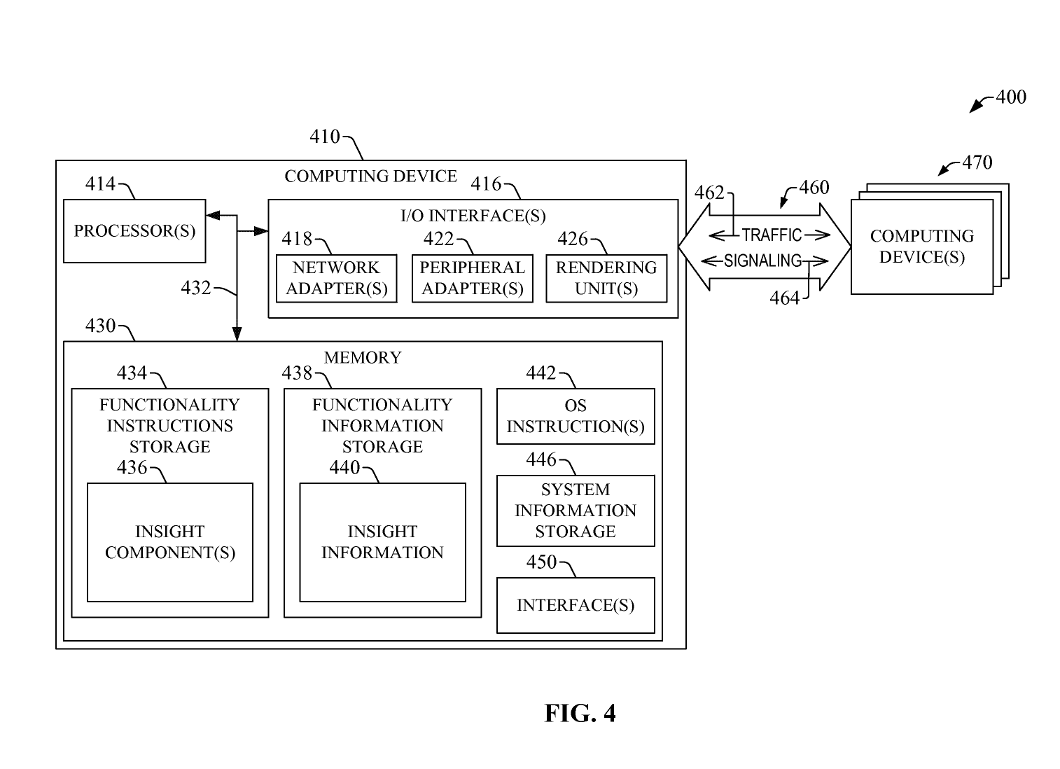

FIG. 4 illustrates a block diagram of an example of an operational environment 400 for generation of organizational intelligence—e.g., determination of organizational insights and management thereof—in accordance with one or more aspects of the disclosure. The example operational environment is merely illustrative and is not intended to suggest or otherwise convey any limitation as to the scope of use or functionality of the operating environment's architecture. In addition, the illustrative operational environment 400 depicted in FIG. 4 should not be interpreted as having any dependency or requirement relating to any one or combination of components illustrated as part of the operational environment 400. The operational environment 400 comprises a computing device 410 which, in various embodiments, can correspond to the computing device 410.

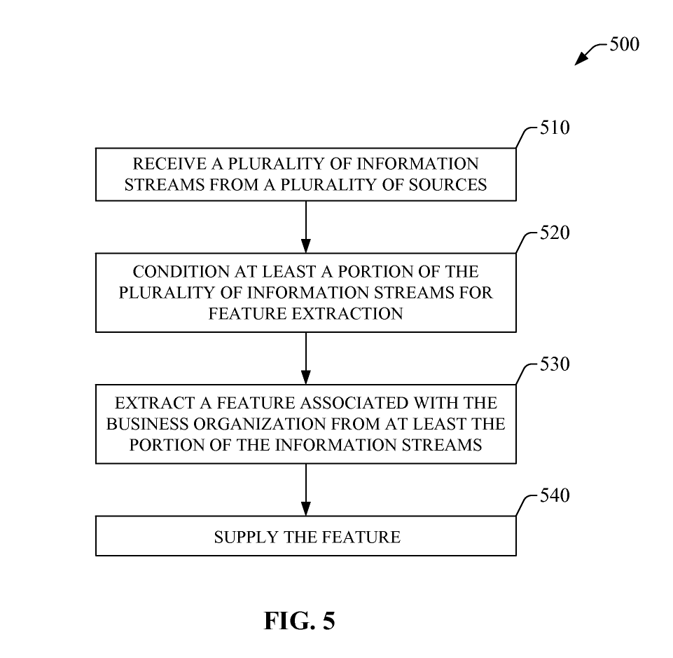

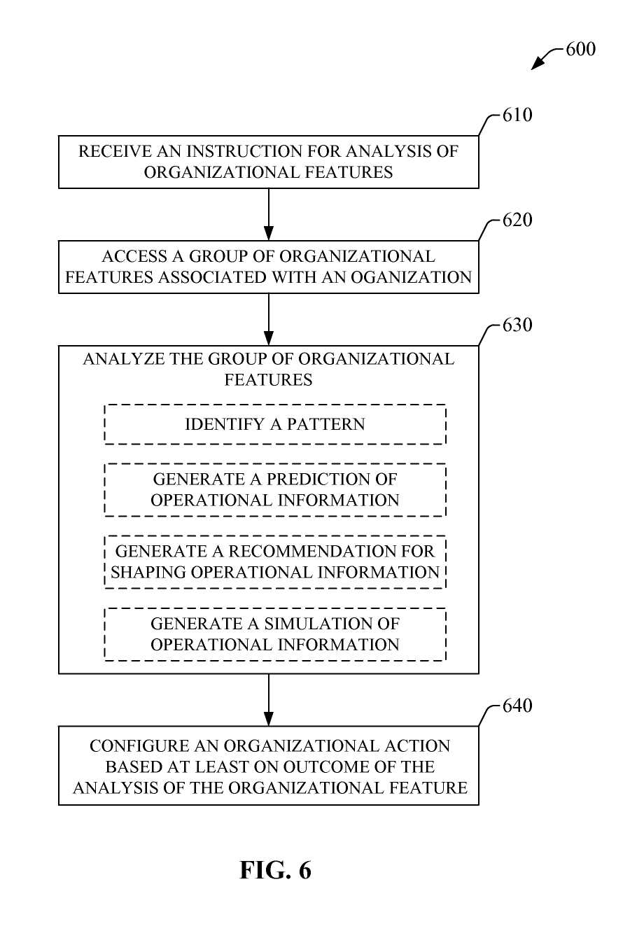

The operational environment 400 represents an example implementation of various aspects of the disclosure in which the processing or execution of operations described in connection with the determination of organizational insights and the management of such insights as disclosed herein can be performed in response to execution of one or more software components at the computing device 410. It should be appreciated that the one or more software components can render the computing device 410, or any other computing device that contains such components, a particular machine for determination of organizational insights and the management of such insights as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein, such as the example methods presented in FIGS. 5-6. For instance, to embody one such method, at least a portion of the computer-accessible instructions can be persisted (e.g., stored, made available, or stored and made available) in a computer storage non-transitory medium and executed by a processor. The one or more computer-accessible instructions that embody a software component can be assembled into one or more program modules that can be compiled, linked, and/or executed at the computing device 410 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 410 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects of the disclosure in connection with the determination of organizational insights and the management of such insights as described herein can comprise personal computers; server computers; laptop devices; handheld computing devices, such as mobile tablets; wearable computing devices; and multiprocessor systems. Additional examples can include set-top boxes, programmable consumer electronics, network PCs, minicomputers, mainframe computers, blade computers, programmable logic controllers (PLCs), distributed computing environments that comprise any of the above systems or devices, or the like.

As illustrated, the computing device 410 can comprise one or more processors 414, one or more input/output (I/O) interfaces 416, one or more memory devices 430 (herein referred to generically as memory 430), and a bus architecture 432 (also termed bus 432) that functionally couples various functional elements of the computing device 410. In certain embodiments, the computing device 410 can include, optionally, a radio unit (not depicted in FIG. 4). The radio unit can include one or more antennas and a communication processing unit that can permit wireless communication between the computing device 410 and another device, such as one of the computing device(s) 470. At least one of the computing device(s) 470 can have similar or identical architecture to the computing device 410. The bus 432 can include at least one of a system bus, a memory bus, an address bus, or a message bus, and can permit exchange of information (data, metadata, and/or signaling) between the processor(s) 414, the I/O interface(s) 416, and/or the memory 430, or respective functional elements therein. In certain scenarios, the bus 432 in conjunction with one or more internal programming interfaces 450 (also referred to as interface(s) 450) can permit such exchange of information. In scenarios in which processor(s) 414 include multiple processors, the computing device 410 can utilize parallel computing.

The I/O interface(s) 416 can permit communication of information between the computing device and an external device, such as another computing device, e.g., a network element or an end-user device. Such communication can include direct communication or indirect communication, such as exchange of information between the computing device 410 and the external device via a network or elements thereof. As illustrated, the I/O interface(s) 416 can comprise one or more of network adapter(s) 418, peripheral adapter(s) 422, and rendering unit(s) 426. Such adapter(s) can permit or facilitate connectivity between the external device and one or more of the processor(s) 414 or the memory 430. For example, the peripheral adapter(s) 422 can include a group of ports, which can comprise at least one of parallel ports, serial ports, Ethernet ports, V.35 ports, or X.21 ports, wherein parallel ports can comprise General Purpose Interface Bus (GPIB), IEEE-1284, while serial ports can include Recommended Standard (RS)-232, V.11, Universal Serial Bus (USB), FireWire or IEEE-1394.

In one aspect, at least one of the network adapter(s) 418 can functionally couple the computing device 410 to one or more computing devices 470 via one or more traffic and signaling pipes 460 that can permit or facilitate exchange of traffic 462 and signaling 464 between the computing device 410 and the one or more computing devices 470. Such network coupling provided at least in part by the at least one of the network adapter(s) 418 can be implemented in a wired environment, a wireless environment, or a combination of both. The information that is communicated by the at least one of the network adapter(s) 418 can result from implementation of one or more operations in a method of the disclosure. Such output can include any form of visual representation, including, but not limited to, textual, graphical, animation, audio, tactile, or the like. In certain scenarios, each of the computing device(s) 470 can have substantially the same architecture as the computing device 410. In addition, or in the alternative, the rendering unit(s) 426 can include functional elements (e.g., lights, such as light-emitting diodes; a display, such as liquid crystal display (LCD), a plasma monitor, a light emitting diode (LED) monitor, an electrochromic monitor; combinations thereof or the like) that can permit control of the operation of the computing device 410, or can permit conveying or revealing the operational conditions of the computing device 410.

In one aspect, the bus 432 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB) and the like. The bus 432, and all buses described herein can be implemented over a wired or wireless network connection and each of the subsystems, including the processor(s) 414, the memory 430 and memory elements therein, and the I/O interface(s) 416 can be contained within one or more remote computing devices 470 at physically separate locations, connected through buses of this form, thereby effectively implementing a fully distributed system.

The computing device 410 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 410, and can comprise, for example, both volatile and non-volatile media, and removable and/or non-removable media. In one aspect, the memory 430 can comprise computer-readable media in the form of volatile memory, such as random access memory (RAM), and/or non-volatile memory, such as read-only memory (ROM).

The memory 430 can comprise functionality instructions storage 434 and functionality information storage 438. The functionality instructions storage 434 can comprise computer-accessible instructions that, in response to execution by at least one of the processor(s) 414, can implement one or more of the functionalities of the disclosure. The computer-accessible instructions can embody or can comprise one or more software components illustrated as insight component(s) 436. In one scenario, execution of at least one component of the insight component(s) 436 can implement one or more of the methods described herein, such as example methods 500 and/or 600. For instance, such execution can cause a processor that executes the at least one component to carry out a disclosed example method. It should be appreciated that, in one aspect, a processor of the processor(s) 414 that executes at least one of the insight component(s) 436 can retrieve information from or retain information in a memory element 440 in the functionality information storage 438 in order to operate in accordance with the functionality programmed or otherwise configured by the insight component(s) 436. Such information can include at least one of code instructions, information structures, or the like. Such instructions and information structures can embody or can constitute machine-learning techniques (e.g., pattern recognition algorithms, inference algorithms, and the like) that can be utilized to implement at least certain functionality described herein. At least one of the one or more interfaces 450 (e.g., application programming interface(s)) can permit or facilitate communication of information between two or more components within the functionality instructions storage 434. The information that is communicated by the at least one interface can result from implementation of one or more operations in a method of the disclosure. In certain embodiments, one or more of the functionality instructions storage 434 and the functionality information storage 438 can be embodied in or can comprise removable/non-removable, and/or volatile/non-volatile computer storage media.

At least a portion of at least one of the insight component(s) 436 or insight information 440 can program or otherwise configure one or more of the processors 414 to operate at least in accordance with the functionality described herein. In one embodiment, the insight component(s) 436 contained in the functionality instruction(s) storage 434 can include one or more of at least one of the interface(s) 112; the exchange unit 116; the conditioning unit 118; at least one of the analysis unit(s) 120 (such as, for example, the pattern extraction unit 310, the prediction unit 320, the simulation unit 330, or the recommendation unit 340, or a combination thereof); or the feature extraction unit 122. It should be recognized that in such an embodiment, hardware or firmware functional elements of the exchange unit 116, the interface(s) 112, the conditioning unit 118, the analysis unit(s) 120, and/or the feature extraction unit 122 can be embodied in suitable components of the computing device 410. For instance, at least one of the processors 414 and at least one of the I/O interface(s) 416 (e.g., a network adapter of the network adapter(s) 418) can embody an interface, (such as the insight dashboard 210) of the interface(s) 112. One or more of the processor(s) 414 can execute at least one of the insight component(s) 436 and leverage at least a portion of the information in the functionality information storage 438 in order to provide organizational insights and management of same in accordance with one or more aspects described herein.

It should be appreciated that, in certain scenarios, the functionality instruction(s) storage 434 can embody or can comprise a computer-readable non-transitory storage medium having computer-accessible instructions that, in response to execution, cause at least one processor (e.g., one or more of processor(s) 414) to perform a group of operations comprising the operations or blocks described in connection with the disclosed methods.

In addition, the memory 430 can comprise computer-accessible instructions and information (e.g., data and/or metadata) that permit or facilitate operation and/or administration (e.g., upgrades, software installation, any other configuration, or the like) of the computing device 410. Accordingly, as illustrated, the memory 430 can comprise a memory element 442 (labeled operating system (OS) instruction(s) 442) that can contain one or more program modules that embody or include one or more operating systems, such as a Windows operating system, Unix, Linux, Symbian, Android, Chromium, or substantially any OS suitable for mobile computing devices or tethered computing devices. In one aspect, the operational and/or architectural complexity of the computing device 410 can dictate a suitable OS. The memory 430 also comprises a system information storage 446 having data and/or metadata that permits or facilitates operation and/or administration of the computing device 410. Elements of the OS instruction(s) 442 and the system information storage 446 can be accessible or can be operated on by at least one of the processor(s) 414.

It should be recognized that while the functionality instructions storage 434 and other executable program components, such as the OS instruction(s) 442, are illustrated herein as discrete blocks, such software components can reside at various times in different memory components of the computing device 410, and can be executed by at least one of the processor(s) 414. In certain scenarios, an implementation of the insight component(s) 436 can be retained on or transmitted across some form of computer-readable media.

The computing device 410 and/or one of the computing device(s) 470 can include a power supply (not shown), which can power up components or functional elements within such devices. The power supply can be a rechargeable power supply, e.g., a rechargeable battery, and it can include one or more transformers to achieve a power level suitable for operation of the computing device 410 and/or one of the computing device(s) 470, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 418) to connect operationally to the conventional power grid. In another aspect, the power supply can include an energy conversion component, such as a solar panel, to provide additional or alternative power resources or autonomy for the computing device 410 and/or at least one of the computing device(s) 470.

The computing device 410 can operate in a networked environment by utilizing connections to one or more remote computing devices 470. As an illustration, a remote computing device can be a personal computer, a portable computer, a server, a router, a network computer, a peer device or other common network node, and so on. As described herein, connections (physical and/or logical) between the computing device 410 and a computing device of the one or more remote computing devices 470 can be made via one or more traffic and signaling pipes 460, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 470) that are functionally coupled (e.g., communicatively linked or otherwise coupled) through a network having traffic and signaling pipes and related network elements. In a distributed computing environment, in one aspect, one or more software components (such as program modules) can be located in both the computing device 410 and at least one remote computing device of the computing device(s) 470, for example. It should be appreciated that in such distributed environments, the functionality for generation of organization intelligence and management thereof can be implemented by the system constituted at least by the computing device 410 and at least one of the computing device(s) 470. Such a system can embody or can contain at least a portion of the example operational environment 100, e.g., the insight management platform 110.

In view of the aspects described herein, examples of techniques for determination and/or management of organizational insights that can be implemented in accordance with at least certain aspects of the disclosure can be better appreciated with reference to the diagrams in FIGS. 5-6. For purposes of simplicity of explanation, the examples of the techniques disclosed herein are presented and described as a series of blocks (with each block representing an action or an operation in a method, for example). However, it is to be understood and appreciated that the disclosed techniques (e.g., process(es), procedure(s), method(s), and the like) are not limited by the order of blocks and associated actions or operations, as some blocks may occur in different orders and/or concurrently with other blocks from that are shown and described herein. For example, the various techniques of the disclosure can be alternatively represented as a series of interrelated states or events, such as in a state diagram. Furthermore, not all illustrated blocks, and associated action(s) or operation(s), may be required to implement a technique in accordance with one or more aspects of the disclosure. Further yet, two or more of the disclosed techniques can be implemented in combination with each other, to accomplish one or more features and/or advantages described herein.

It should be appreciated that the techniques of the disclosure can be retained on an article of manufacture, or computer-readable storage medium in order to permit or facilitate transporting and transferring such methods to a computing device (e.g., a desktop computer; a mobile computer, such as a tablet, or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable storage medium, to implement the one or more methods. The code instructions can embody or can constitute the techniques, and thus can provide a computer-executable or machine-executable framework to implement the techniques described herein.

FIG. 5 presents a flowchart of an example of a method 500 for determining or otherwise accessing an organizational insight in accordance with at least certain aspects of the disclosure. In certain embodiments, a system (e.g., a system contained within computational environment 400) having one or more processors coupled (individually or in groups) with one or more memory devices having computer-accessible instructions (or instructions) encoded thereon can implement one or more blocks of the subject example method. At block 510, a plurality of information streams (e.g., data streams, metadata streams, and/or signaling streams) can be received from a plurality of sources. In certain scenarios, the plurality of information streams can include unstructured data, and at least a portion of such information can be received over a predetermined time interval. As described herein, in one aspect, at least one of the plurality of information streams can be associated with an organization (e.g., a business organization).

At block 520, at least a portion of the plurality of information streams can be conditioned for feature extraction. As described herein, in one aspect, feature extraction can permit determining a feature or an insight associated with the organization. Conditioning at least the portion of the plurality of information for feature extraction can include normalizing information contained in each stream of at least the portion of the plurality of information streams. In addition or in the alternative, conditioning at least the portion of the plurality of information for feature extraction can include parsing information contained in the portion of the plurality of information streams, and configuring the information for the feature extraction. In one aspect, configuring at least a portion of the information that is parsed can include formatting the information according to a format suitable to implement a map-reduce scheme. In certain implementations, at least the portion of the plurality of information streams can include at least two information streams (e.g., an organizational information stream and a non-organizational information stream), which can permit extracting rich features from the available information.

At block 530, a feature associated with the organization can be extracted from the information. Extracting the feature can include correlating at least two information streams that can be contained in at least the portion of the plurality of information streams. In addition or in the alternative, extracting the feature can include determining a function of a group of variables and/or parameters included in at least the portion of the plurality of information streams. For instance, the function can be a deviation function G of average daily revenue [symbol] R_{D} [symbol] of a business and daily revenue R_{D|T} of the business during a day in which atmospheric temperature T is above certain threshold T₀, where the deviation is estimated over a certain number of days N: G=G(R_{D}, R_{D|T})=Σ_{{i-1,N}}| [symbol] R_{D} [symbol] −R_{D|T}|². Such a function can gauge the effect of temperature on business revenue. In other embodiments, the function can be representative of revenue of an item within a specific category when atmospheric temperature has certain value. In yet other embodiments, another suitable function can be representative of the revenue of a business when a second business of the same type (e.g., same NAICS codes and/or size) has a promotional sale in the area of operation of the business. In yet other embodiments, the function can be

[symbol]

At block 540, the feature can be supplied. As described herein, in certain implementations, supplying the feature can include retaining the feature in a memory element (e.g., a register, a file, a database or other data structure, or the like) contained in a feature aggregation layer including a feature information repository. The feature can be retained according to various factors, such as one or more of a source platform of the plurality of source platforms, an information category, a business metric, or a time span. In addition or in the alternative, the memory element in which the feature can be retained can contain a group of historical features.

FIG. 6 presents a flowchart of an example of a method 600 for managing or otherwise utilizing organizational insights in accordance with at least certain aspects of the disclosure. In certain embodiments, a system (e.g., a system contained within computational environment 400) having one or more processors coupled (individually or in groups) with one or more memory devices having computer-accessible instructions (or instructions) encoded thereon can implement one or more blocks of the subject example method. At block 610, an instruction for analysis of organizational features can be received. The instruction can determine a group of operations to be applied to the organization features, and in certain scenarios, can contain information (e.g., data and/or metadata) that can specify the scope of the analysis. At block 620, a group of organizational features can be accessed. Such a group can be associated with an organization and can include one or more of a contemporaneous feature or a historical feature. In one implementation, at least a portion of the group of organizational features can be accessed by querying or otherwise probing a database (either relational or non-relational), and/or by selecting a view of the database according to a predetermined criterion that may be associated with the analysis. At block 630, the group of organizational features can be analyzed. As described herein, various types of analyses can be conducted. For example, analyzing such features can include identifying or otherwise determining a pattern present in the group of features, where the pattern can include a time-domain pattern, a space-domain feature, or a feature-domain pattern. For another example, analyzing the group of organizational features can include predicting (or generating a prediction) of operational information (e.g., data and/or metadata) associated with the organization (e.g., a business organization). For yet another example, analyzing the group of organizational features can include generating a recommendation for shaping (e.g., configuring or otherwise adjusting/customizing) operational information associated with the organization. In still another example, analyzing the group of organizational features can include simulating (or generating a simulation of) an operational metric of the business organization. Combinations of two or more of the foregoing analyses also can be performed. At block 640, an organizational action can be configured, at least in part by the system, for example, based at least on outcome of the analysis of the organizational features.

Several advantages over conventional technologies for acquisition, analysis, and/or management of organizational information emerge from the present specification and annexed drawings. One example advantage may include availability of rich information originated in a variety of disparate source platforms that can be mined automatically in time scales having various resolution, including in realtime or nearly in realtime. As the information that can be relied upon for the determination and/or management of organizational insights is not collected automatically as opposed to manually, the information streams available for such determination and/or management can be mined nearly continuously in certain embodiments, with the ensuing availability of nearly realtime assessment (e.g., correlation generation and/or identification of trends) and/or planning of the operation of an organization. Another example advantage may include dynamic generation and/or revision of available organizational knowledge, which can include a collection of organizational insights. Yet another advantage may include the specificity of the organization knowledge that is provided in accordance with aspects of the disclosure. The organizational insights are specific to an organization and its environment, rather than generic to certain segment or industry vertical of the organization. The specificity of the organizational insights includes specificity in time-domain (e.g., an insight applicable or otherwise pertinent to certain day of the week, such effect of gas prices on customer traffic on a Friday) and/or space-domain.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “platform,” “architecture,” “interface,” “unit,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “platform,” “architecture,” “interface,” “unit,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer-program products that can provide organizational insights and management thereof. It is, of course, not possible to describe every conceivable combination of elements and/or methods for purposes of describing the various features of the disclosure, but it can be recognize that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A method for generating institutional intelligence, comprising:
receiving a plurality of information streams from a plurality of source platforms over a time interval, at least one of the plurality of information streams being associated with a business organization;
conditioning at least a portion of the plurality of information streams for feature extraction, wherein at least the portion of the plurality of information streams includes at least two information streams, and wherein the conditioning comprises normalizing information included in each stream of at least the portion of the plurality of information streams; and
extracting a feature associated with the business organization from the information, wherein the extracting comprises correlating the at least two information streams.

2. The method of claim 1, further comprising supplying the feature.

3. The method of claim 2, wherein the supplying comprises retaining the feature in a memory element according to one or more of a source platform of the plurality of source platforms, a category, a business metric, or a time span.

4. The method of claim 2, further comprising retaining the feature in a memory element having a group of historical features.

5. The method of claim 1, further comprising accessing a group of features of associated with the business organization, wherein the group of features includes one or more of a contemporaneous feature or a historical feature.

6. The method of claim 5, further comprising identifying a pattern present in the group of features, wherein the pattern includes a time-domain pattern, a space-domain pattern, or a feature-domain pattern.

7. The method of claim 5, further comprising generating a prediction of operational information associated with the business organization.

8. The method of claim 5, further comprising generating a simulation of an operational metric of the business organization.

9. The method of claim 1, wherein the extracting comprises determining a function of a group of variables included in at least the portion of the plurality of information streams.

10. The method of claim 1, wherein the conditioning further comprises parsing information included in the portion of the plurality of information streams, and configuring the information for the feature extraction.

11. The method of claim 10, wherein the configuring comprising formatting the information according to a format suitable to implement a map-reduce scheme.

12. At least one computer-readable non-transitory storage medium encoded with computer-accessible instructions that, in response to execution, cause at least one processor to perform generation of institutional intelligence operations comprising:
receiving a plurality of information streams from a plurality of source platforms over a time interval, at least one of the plurality of information streams being associated with a business organization;
conditioning at least a portion of the plurality of information streams for feature extraction, wherein at least the portion of the plurality of information streams includes at least two information streams, and wherein the conditioning comprises normalizing information included in each stream of at least the portion of the plurality of information streams; and
extracting a feature associated with the business organization from the information, wherein the extracting comprises correlating the at least two information streams.

13. The least one computer-readable non-transitory storage medium of claim 12, the generation of institutional intelligence operations further comprising retaining the feature in a memory element according to one or more of a source platform of the plurality of source platforms, a category, a business metric, or a time span.

14. The at least one computer-readable non-transitory storage medium of claim 12, the generation of institutional intelligence operations further comprising retaining the feature in a memory element having a group of historical features.

15. The at least one computer-readable non-transitory storage medium of claim 12, the generation of institutional intelligence operations further comprising accessing a group of features of associated with the business organization, wherein the group of features includes one or more of a contemporaneous feature or a historical feature.

16. The at least one computer-readable non-transitory storage medium of claim 15, the generation of institutional intelligence operations further comprising identifying a pattern present in the group of features, wherein the pattern includes a time-domain pattern, a space-domain pattern, or a feature-domain pattern.

17. The at least one computer-readable non-transitory storage medium of claim 15, the generation of institutional intelligence operations further comprising further comprising generating a prediction of operational information associated with the business organization.

18. The at least one computer-readable non-transitory storage medium of claim 15, the generation of institutional intelligence operations further comprising further comprising generating a simulation of an operational metric of the business organization.

19. The at least one computer-readable non-transitory storage medium of claim 12, wherein the plurality of information streams comprises unstructured data.

20. The at least one computer-readable non-transitory storage medium of claim 12, wherein the extracting comprises determining a function of a group of variables included in at least the portion of the plurality of information streams.

21. A system for generation of institutional intelligence, comprising:
at least one memory device having instructions encoded thereon; and
at least one processor functionally coupled to the at least one memory device and configured to execute the instructions, and in response to execution of the instructions, further configured to:
receive a plurality of information streams from a plurality of source platforms over a time interval, at least one of the plurality of information streams being associated with a business organization;
condition at least a portion of the plurality of information streams for feature extraction, wherein at least the portion of the plurality of information streams includes at least two information streams, and wherein the conditioning comprises normalizing information included in each stream of at least the portion of the plurality of information streams; and
extract a feature associated with the business organization from the information, wherein the extracting comprises correlating the at least two information streams.

22. The system of claim 21, in response to execution of the instructions, the at least one processor being further configured to access a group of features of associated with the business organization, wherein the group of features includes one or more of a contemporaneous feature or a historical feature.

23. The system of claim 22, in response to execution of the instructions, the at least one processor being further configured to identify a pattern present in the group of features, wherein the pattern includes a time-domain pattern, a space-domain pattern, or a feature-domain pattern.

24. The system of claim 22, in response to execution of the instructions, the at least one processor being further configured to generate a prediction of operational information associated with the business organization.

25. The system of claim 22, in response to execution of the instructions, the at least one processor being further configured to generate a simulation of an operational metric of the business organization.

26. The system of claim 21, wherein to extract the feature associated with the business organization from the information, the at least one processor being further configured, in response to execution of the instructions, to determine a function of a group of variables included in at least the portion of the plurality of information streams.
